(19) United States
(12) Patent Application Publication
(10) Pub. No.: US 2005/0169608 A1
(43) Pub. Date: Aug. 4, 2005

(54) Method for adjusting display of sub-picture in audio/video playback device

(76) Inventors: Chin-Cheng Shen, Hsin-Tien City (TW); Max Chen, Hsin-Tien City (TW)

Correspondence Address: J.C. Patents, Suite 250, 4 Venture, Irvine, CA, 92618, US

(21) Appl. No.: 11/031,436

(22) Filed: Jan. 7, 2005

(30) Foreign Application Priority Data
Jan. 7, 2004 (TW) 93100318

(51) Int. Cl. H04N 5/76; H04N 5/781

(52) U.S. Cl. 386/95; 386/98

(57) ABSTRACT

A method for adjusting a display of a sub-picture in an audio/video (AV) playback device is disclosed. The method provides a set of sub-picture adjusting parameter for adjusting display format of the sub-picture. The set of sub-picture adjusting parameter includes a sub-picture location adjusting parameter for adjusting display location of the sub-picture or a sub-picture size adjusting parameter for adjusting display size of the sub-picture. An input apparatus of the AV playback device is used to set the set of sub-picture adjusting parameter. The AV playback device determines, adjusts and displays the sub-picture according to the set of sub-picture adjusting parameter.

### CROSS-REFERENCE TO RELATED APPLICATION

This application claims the priority benefit of Taiwan application serial no. 93100318, filed on Jan. 7, 2004.

### BACKGROUND OF THE INVENTION

1. Field of Invention

The invention relates to and, in particular, to a method for adjusting display result in an audio/video playback device and, the invention relates to and, in particular, to a method for adjusting a display format of a sub-picture in the audio/video playback device.

2. Related Art

Since development of the storage medium having great progress recently, many high stability and capacity products and related applications become available. For instance, the digital versatile disk (DVD) is being substituted for the video compact disk (VCD) for storing higher quality image. Moreover, The DVD-Video specification provides the information about compression format of dynamic image, frame rate, and so on. In addition, the specification further provides the description of sub-picture mechanism for film viewer to interact with the digital content of the film.

With reference to FIG. 1, a skeleton diagram showing a display frame played by a DVD player includes a display frame 110 and a sub-picture 120. A DVD-Video supports at most 32 sub-picture streams for various menus, symbols, animation, aural auxiliary, and multi-language supporting functions, and the sub-picture can be viewed as a sequence of compressed bitmap for decoding and overlapping with other data to be displayed according to corresponding timestamp and location parameter.

With reference to FIG. 2, a flow chart showing a sub-picture displaying method of the prior art includes the steps of retrieving, decoding, and converting a sub-picture into a bitmap in step 210, and overlapping the bitmap with other data to be displayed such as decoded image and graph for forming a frame according to the corresponding timestamp and location parameter in step 220. Furthermore, outputting each frame to a display according to the related sequence and bit rate.

However, since the individual preference different during film watching, and the sub-picture arrangement maybe improper for film viewer, the prosecution will result from the situation mentioned above. For example, the display location and size of the sub-picture of a DVD disk is often fixed, the application is fewer and the usability low while the film of the ratio 16 to 9 with the sub-picture of the DVD disk is played in a TV of the ratio 4 to 3. In other words, the existing dark region located on both upper and lower side of the active display area can't be utilized for display the sub-picture.

### SUMMARY OF THE INVENTION

A method for adjusting a display of a sub-picture in an audio/video playback device, which includes the steps of providing a set of sub-picture adjusting parameter; wherein the set of sub-picture adjusting parameter comprises a sub-picture to be adjusted location parameter; a sub-picture location adjusting parameter, and a sub-picture size adjusting parameter; determining a sub-picture as a sub-picture to be adjusted according to the a sub-picture to be adjusted location parameter; and adjusting the sub-picture to be adjusted according to the set of sub-picture adjusting parameter comprising of adjusting a location of the sub-picture according to the sub-picture location adjusting parameter, and adjusting a size of the sub-picture according to the sub-picture size adjusting parameter.

A method of adjusting a display of a sub-picture in an audio/video playback device, which includes the steps of providing a set of sub-picture adjusting parameter, wherein the set of sub-picture adjusting parameter further comprises a sub-picture to be adjusted location parameter and at least a sub-picture display format adjusting parameter; determining a sub-picture as a sub-picture to be adjusted according to the sub-picture to be adjusted location parameter; and adjusting a display format of the sub-picture to be adjusted according to the set of sub-picture adjusting parameter.

A method of adjusting a display of a sub-picture in an audio/video playback device, which includes the steps of retrieving a sub-picture; providing a set of sub-picture adjusting parameter, wherein the set of sub-picture adjusting parameter further comprises a sub-picture to be adjusted location parameter and at least a sub-picture display format adjusting parameter; determining the sub-picture as a sub-picture to be adjusted according to the sub-picture to be adjusted location parameter; adjusting a display format of the sub-picture to be adjusted according to the set of sub-picture adjusting parameter; and integrating a sub-picture adjusted with other data to be displayed and outputting to a display.

### BRIEF DESCRIPTION OF THE DRAWINGS

The invention will become more fully understood from the detailed description given herein below illustration only, and thus is not limitative of the present invention.

FIG. 1 is a skeleton diagram showing a display frame played by a DVD player according to the prior art.

FIG. 2 is a flow chart showing a sub-picture displaying method of the prior art.

FIG. 3 is a flow chart showing a method for adjusting a display of a sub-picture in an audio/video playback device according to an embodiment of the invention.

FIG. 4A is a skeleton diagram showing an adjustment of sub-picture display location according to an embodiment of the invention.

FIG. 4B is a skeleton diagram showing an adjustment of sub-picture size according to an embodiment of the invention.

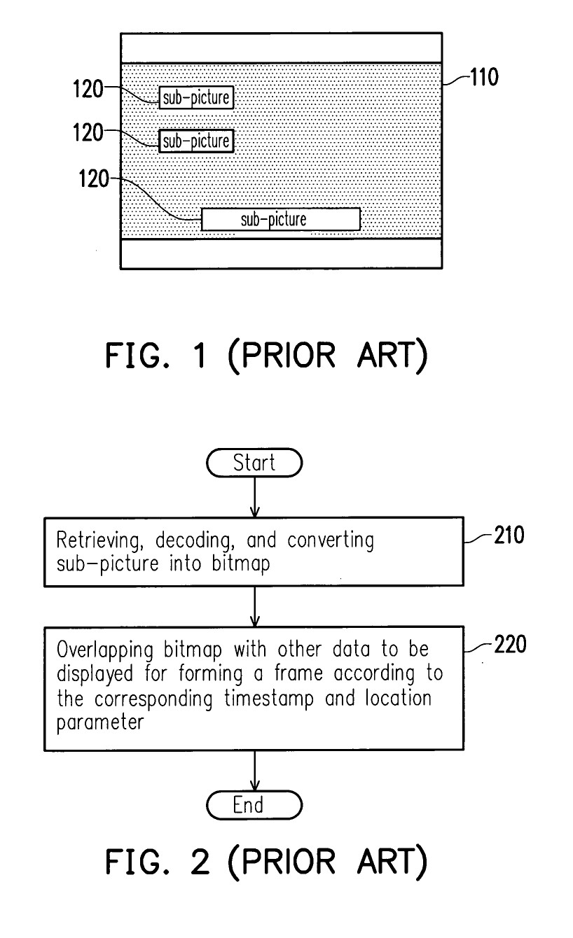

### DETAILED DESCRIPTION OF THE INVENTION

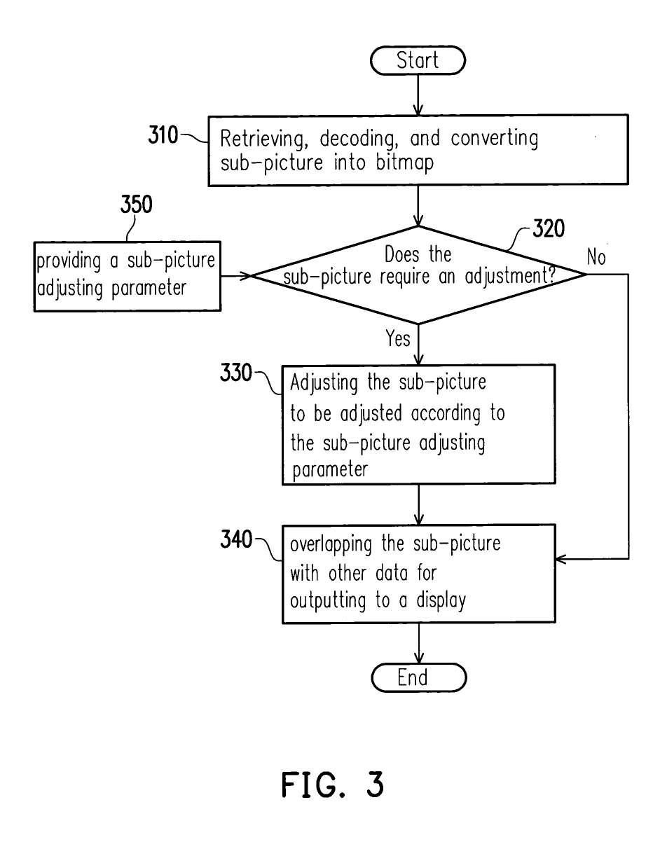

With reference to FIG. 3, a flow chart showing a method for adjusting a display of a sub-picture in an audio/video playback device includes the steps of retrieving, decoding, and converting a sub-picture into a bitmap in step 310, and determining whether the sub-picture requires an adjustment according a sub-picture to be adjusted location parameter in step 320. In the embodiment, the sub-picture to be adjusted location parameter may be the left-upper and the right-lower coordinate of a diagonal of a rectangular display area for judging whether the sub-picture overlaps a current sub-picture and further for adjusting and display the sub-picture. In addition, the sub-picture to be adjusted location parameter may also be a sub-picture frame number such as zero to 31 as a basis for adjusting the sub-picture having a corresponding number equals to the sub-picture frame number. Moreover, the sub-picture adjusting parameter further includes a sub-picture size adjusting parameter.

Furthermore, adjusting the sub-picture to be adjusted according to the sub-picture adjusting parameter while the size or location of the sub-picture is not equal to the preset size or location in step 330, and overlapping the sub-picture with other data for outputting to a display such as a TV in step 340. Moreover, the method includes a step of providing a sub-picture adjusting parameter in step 350.

The sub-picture adjustment may be implemented in performing the firmware or by logic circuits. Hence, in another embodiment, loading the last value or a decoded frame data stored in a disk as an initial value of the sub-picture adjusting parameter during starting up the audio/video playback device. In addition, each sub-picture has corresponding sub-picture adjusting parameter.

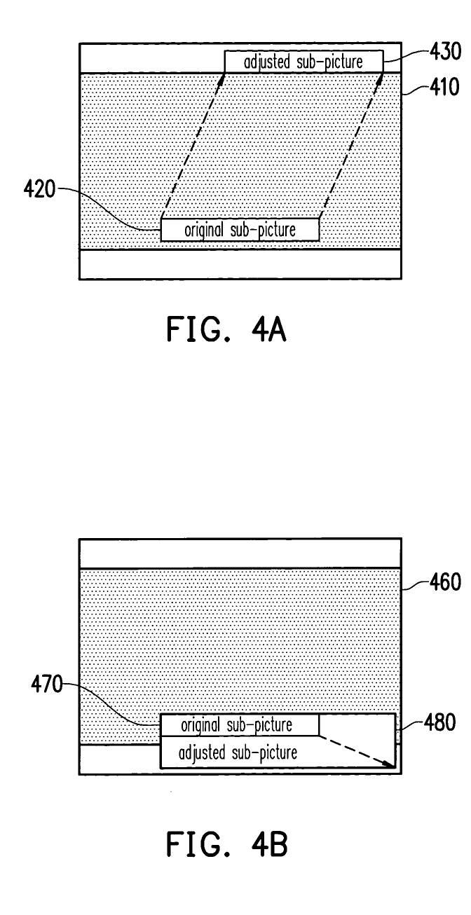

With reference to FIG. 4A, a skeleton diagram of an adjustment of sub-picture display location in an audio/video playback device is shown. In the embodiment, an original sub-picture 420 of a active display area 410 intending to be shifted and then as an adjusted sub-picture 430, herein the location of the original sub-picture 420 is obtained through decoding. In one embodiment, the location of the sub-picture is defined by two coordinates of a diagonal of a rectangular display area, and the sub-picture location adjusting parameter includes an original location parameter and an intended location parameter for recording a pair of original diagonal coordinates and a corresponding intended coordinate respectively. Accordingly, the audio/video playback device comparing the coordinates for judging the requirement of adjusting the location of sub-picture. In addition, the sub-picture location adjusting parameter may store to a volatile and non-volatile memory of the audio/video playback device.

With reference to FIG. 4B, a skeleton diagram of an adjustment of sub-picture size is shown. In the embodiment, the original sub-picture 470 of a active display area 460 may be scaled up and scaled down for forming an adjusted sub-picture 480. The sub-picture size adjusting parameter can be a floating point value for recording corresponding scaling ratio, and two sets of floating point values for recording horizontal and vertical scaling ratio respectively in another embodiment, and further provide the audio/video playback device for performing the expression such as interpolation and extraction. In addition, the sub-picture size adjusting parameter may store to a volatile or non-volatile memory.

Moreover, the sub-picture size adjusting parameter and the sub-picture location adjusting parameter both can be employed without fixed sequence for sub-picture location and size adjustment in one embodiment. Besides, the sub-picture adjusting parameter either preset value, or user is dynamic adjusting.

For the operation mentioned above, there exists many setting options and related inputting apparatus such as a remote controller with direction button which includes the setting options of sub-picture location parameter setting, sub-picture size parameter setting, and sub-picture to be adjusted location parameter for user to select preferred effect. In addition, user can adjust the size and location of the sub-picture rapidly through selecting the provided preset value or inputting the intended value directly.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A method for adjusting a display of a sub-picture in an audio/video playback device, comprising:
providing a set of sub-picture adjusting parameter; wherein the set of sub-picture adjusting parameter comprises a sub-picture to be adjusted location parameter; a sub-picture location adjusting parameter, and a sub-picture size adjusting parameter;
determining a sub-picture as a sub-picture to be adjusted according to the a sub-picture to be adjusted location parameter; and
adjusting the sub-picture to be adjusted according to the set of sub-picture adjusting parameter comprising of adjusting a location of the sub-picture according to the sub-picture location adjusting parameter, and adjusting a size of the sub-picture according to the sub-picture size adjusting parameter.

2. The method of claim 1, wherein the sub-picture location adjusting parameter comprising two coordinates of at least a diagonal of a rectangular display area.

3. The method of claim 2, wherein setting of two coordinates of the diagonal of the rectangular display area through an input apparatus of an audio/video playback device.

4. The method of claim 1, wherein the sub-picture location adjusting parameter comprising an original location parameter and an intended location parameter.

5. The method of claim 1, wherein setting the sub-picture size adjusting parameter from a plurality sets of preset size adjusting parameter through an input apparatus of an audio/video playback device.

6. The method of claim 1, wherein setting the sub-picture size adjusting parameter through making choice of an intended area of a sub-picture display area by an input apparatus of an audio/video playback device, and calculating scaling ratio of the intended area and an original display area.

7. The method of claim 1, wherein setting the sub-picture size adjusting parameter by inputting a sub-picture size required through an input apparatus of an audio/video playback device directly.

8. A method of adjusting a display of a sub-picture in an audio/video playback device, comprising:
providing a set of sub-picture adjusting parameter, wherein the set of sub-picture adjusting parameter further comprises a sub-picture to be adjusted location parameter and at least a sub-picture display format adjusting parameter;
determining a sub-picture as a sub-picture to be adjusted according to the sub-picture to be adjusted location parameter; and
adjusting a display format of the sub-picture to be adjusted according to the set of sub-picture adjusting parameter.

9. The method of claim 8, wherein the sub-picture to be adjusted location parameter comprising two coordinates of at least a diagonal of a rectangular display area.

10. The method of claim 9, wherein adjusting the display format of the sub-picture to be adjusted further comprising:
adjusting size of the sub-picture to be adjusted according to a sub-picture size adjusting parameter.

11. A method of adjusting a display of a sub-picture in an audio/video playback device, comprising:
retrieving a sub-picture;
providing a set of sub-picture adjusting parameter, wherein the set of sub-picture adjusting parameter further comprises a sub-picture to be adjusted location parameter and at least a sub-picture display format adjusting parameter;
determining the sub-picture as a sub-picture to be adjusted according to the sub-picture to be adjusted location parameter; adjusting a display format of the sub-picture to be adjusted according to the set of sub-picture adjusting parameter; and
integrating a sub-picture adjusted with other data to be displayed and outputting to a display.

12. The method of claim 11, further comprising:
retrieving and then decoding the sub-picture.

13. The method of claim 11, wherein the sub-picture to be adjusted location parameter comprising two coordinates of at least a diagonal of a rectangular display area.

14. The method of claim 11, wherein adjusting the display format of the sub-picture to be adjusted further comprising:
adjusting location of the sub-picture to be adjusted according to sub-picture to be adjusted location parameter.

15. The method of claim 9, wherein adjusting the display format of the sub-picture to be adjusted further comprising:
adjusting size of the sub-picture to be adjusted according to a sub-picture size adjusting parameter.
